(19) United States
(12) Patent Application Publication
(10) Pub. No.: US 2008/0296277 A1
(43) Pub. Date: Dec. 4, 2008

(54) INDUCTION HEATED, HOT WIRE WELDING

(76) Inventor: Michael D. McAninch, Goode, VA (US)

Correspondence Address: BWX TECHNOLOGIES, INC.;LAW DEPARTMENT - INTELLECTUAL PROPERTY, 91 STIRLING AVENUE, (MAIL STATION BWO11E), BARBERTON, OH, 44203-0271, US

(21) Appl. No.: 11/755,795

(22) Filed: May 31, 2007

(51) Int. Cl. B23K 9/167

(52) U.S. Cl. 219/136

(57) ABSTRACT

A hot wire welding process. An induction coil is used to preheat the filler metal wire prior to its entering the welding puddle/arc region. An induction coil is placed in close proximity to the welding arc. The filler wire is guided by the delivery nozzle so that the filler wire passes through the center of the induction coil. The induction coil induces a current flow in the filler wire. The current produces heat as a result of the electrical resistivity of the filler wire. The heat produced raises the temperature of the filler wire just before it is fed into the weld arc region, thus reducing the energy required from the welding arc to melt the filler metal wire into the weld puddle.

### FIELD AND BACKGROUND OF INVENTION

The hot wire process has been used almost exclusively with gas tungsten arc welding. The hot wire gas tungsten arc welding (GTAW) process is an arc welding process that uses an electric arc between a non-consumable tungsten/tungsten alloy electrode and the work piece to create a molten weld pool. The region immediately around the electrode is protected by the flow of a shielding gas that protects the electrode tip, weld pool, and solidifying weld metal from atmospheric contamination. The arc is produced by passing electrical current from the electrode to the work piece through the conductive ionized shielding gas column. Heat generated from the welding arc is used to melt the base material to form a weld puddle. The electrode can be progressively moved along the surface of the work piece to produce a weld pass. A consumable filler wire is added into the weld puddle to provide material to fill a weld groove or create a weld buildup. For the conventional GTAW process, the energy to melt the filler wire also comes from the heat generated by the welding arc. In the HW-GTAW process variant, the filler wire is pre-heated just prior to its being fed into the welding pool. Preheating reduces the amount of energy needed from the welding arc to melt the filler wire, thereby increasing the efficiency of the process and permitting higher deposition rates of filler wire to be used.

From an industry review, all practical applications for the hot wire process have involved HW-GTAW utilizing a resistive heating technique to preheat the filler wire (see FIG. 1). An electrical contactor is placed in direct contact with the filler wire in close proximity to the weld puddle; current flows through the contactor to the filler wire and into the weld puddle. This current flow preheats the filler wire by the heat produced from the resistivity of the filler material. This technique of preheating requires the end of the filler wire to remain in direct contact with the weld puddle to maintain the electrical circuit for the preheating current.

The current hot wire technique has some limitations. The filler wire must maintain physical contact with the weld puddle to provide a continuous electrical circuit. This requirement restricts the entry position of the filler wire for conventional HW-GTAW to the trailing edge of the weld puddle. The trailing edge (i.e. behind the weld torch) is the position where the weld puddle is most accessible to filler wire.

### SUMMARY OF INVENTION

The present invention addresses the limitations in the known art and is drawn to an improvement of the hot wire welding process. Here, an induction coil is used to preheat the filler metal prior to its entering the welding puddle/arc region. An induction coil is placed in close proximity to the welding arc. The filler wire is guided by the delivery nozzle so that the filler wire passes through the center of the induction coil. The induction coil induces a current flow in the filler wire. The current produces heat as a result of the electrical resistivity of the filler wire. The heat produced raises the temperature of the filler wire just before it is fed into the weld arc region, thus reducing the energy required from the welding arc to melt the filler metal into the weld puddle.

The various features of novelty which characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated as configured for, but not limited to, the gas tungsten arc process.

### BRIEF DESCRIPTION OF THE DRAWINGS

In the accompanying drawings, forming a part of this specification, and in which reference numerals shown in the drawings designate like or corresponding parts throughout the same:

FIG. 1 illustrates the prior art Hot Wire Gas Tungsten Arc Welding arrangement.

FIG. 2 illustrates the arrangement of the invention.

### DESCRIPTION OF THE PREFERRED EMBODIMENT

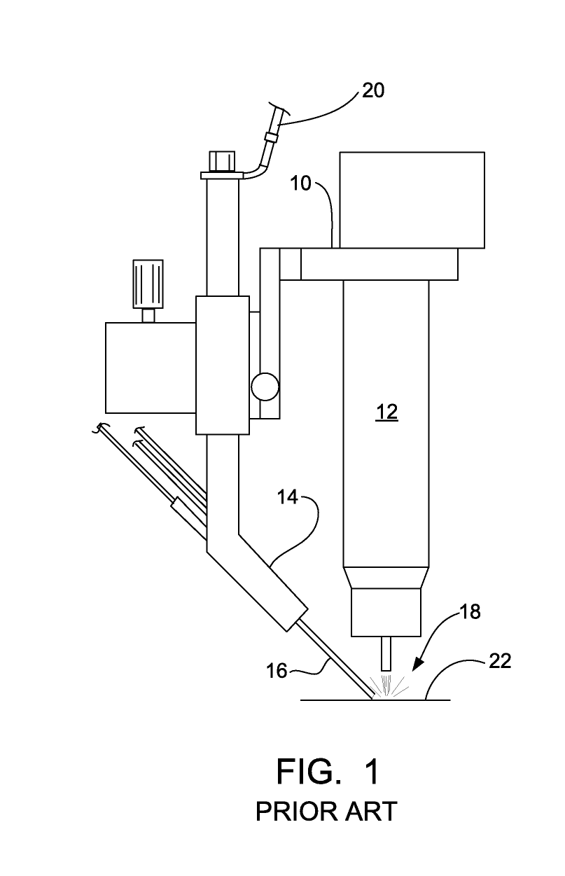

The prior art arrangement for HW-GTAW (hot wire gas tungsten arc welding) is illustrated in FIG. 1. A framework 10 supports the gas tungsten arc torch 12, and a delivery guide 14 for the filler metal wire 16. The delivery guide 14 is used to guide the filler metal wire 16 to the area of the welding arc 18 adjacent the gas tungsten arc torch 12. Means for delivering electrical current to the filler metal wire 16 is supported on the framework. An electrical cable 20 is provided with an electrical contact that is in contact with the filler metal wire 16 in the delivery guide 14 in close proximity to the welding arc 18 to deliver a current into the filler wire 16. The electrical current preheats the wire 16 before it reaches the welding arc 18 as long as the filler wire 16 maintains a closed electrical circuit by remaining in contact with the weld puddle on the work piece 22.

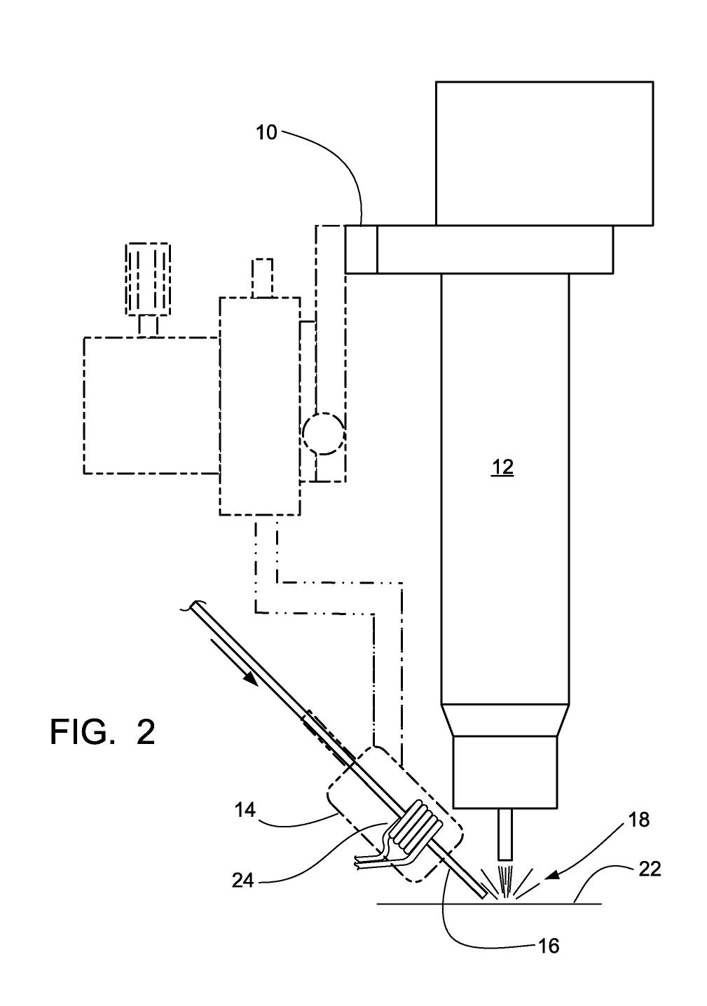

FIG. 2 illustrates the arrangement of the invention. The framework 10, gas tungsten arc torch 12, delivery guide 14, and filler metal wire 16 all are used in the same manner as the prior art. The difference from the prior art is that a different means is used to preheat the filler wire 16 before it comes into the area of the welding arc 18.

In the preferred embodiment, a circular induction coil 24 is held in position by the delivery guide 14 such that the induction coil surrounds, but is not in contact with, the filler metal wire 16. The induction coil 24 is connected to an electrical current source, not shown, that delivers a current through the induction coil 24. The current through the induction coil 24 induces a magnetic field in the immediate area of the coil. The magnetic field affects the filler metal wire 14 by inducing an electrical current in the filler metal wire 16. The natural electrical resistance of the metal wire 16 results in the creation of heat in the metal wire 16 that serves to preheat and soften the filler metal wire 16 before it enters the area of the welding arc 18. The end result is that less energy from the welding arc 18 is required to melt the filler metal wire 16 into the weld pool on the work piece 22.

As an alternate embodiment, the induction coil 24 may be of a non-circular shape and be positioned adjacent to, but not surrounding the metal filler wire 16.

The invention was conceived as a means of overcoming the limitation of the conventional HW-GTAW process where the filler wire must maintain physical contact with the weld puddle to provide a continuous electrical circuit. The invention eliminates the need for direct contact with the weld puddle, thereby providing complete freedom on the entry position of the filler wire. Wire entry position can now be based upon the requirements and needs of the specific application being welded.

This invention of heating a filler wire for welding using an induction coil provides the same advantages as described for gas tungsten arc welding to other welding process such as, but not limited to, submerged arc welding.

The advantages of the invention, as compared to conventional HW-GTAW, include the following.

The induction heating system eliminates the need for a continuous electrical circuit between the filler wire and the weld puddle. By eliminating this requirement, the process permits the user to choose from a variety of positions for the entry of the filler wire into the weld puddle/arc column. The filler wire can be fed into the leading edge of the puddle, from the side, from the back and any off-angle position desired. In addition, the filler wire can be fed in above the puddle into the arc column itself.

The invention eliminates the formation of magnetic arc blow as a result of current flowing between the filler wire and the weld puddle.

The invention eliminates electrical erosion of the wire guide nozzle as a result of micro-arcing that occurs between the sliding contact of the filler wire and the guide nozzle for conventional HW-GTAW.

To create a sound weld, the welding arc must provide sufficient energy to raise the temperature of both the base and weld filler materials to their respective melting temperatures and create a common weld puddle. For a given set of welding conditions (amperage, voltage, travel speed, etc.) there is an optimal feed rate for the filler wire, where the deposition rate is maximized while still having sufficient energy from the arc to melt the surrounding base material to produce a sound weld. If the filler metal feed rate is increased beyond this critical point the arc will no longer have enough energy to melt all of the material (base and/or filler). By preheating the filler metal just prior to its entry into the weld puddle, less energy is required from the arc to raise the temperature of the filler wire to its melting point. Thus, for a given set of welding conditions, additional filler metal can be melted using the hot wire induction arrangement (as compared to cold wire) before the welding process reaches the critical point for poor weld quality.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles.

What is claimed as invention is:

1. In an improved hot wire welding process where a filler metal passes through a delivery guide to the area of the welding arc, the improvement comprising:
an induction coil adjacent the filler metal that induces a current in the filler metal, producing heat in the filler metal.

2. The improved hot wire welding arrangement of claim 1, wherein the induction coil surrounds the filler metal.

3. The improved hot wire welding arrangement of claim 2, wherein the induction coil is circular.

4. The improved hot wire welding arrangement of claim 1, wherein the induction coil is located in close proximity to the welding arc.

5. In an improved hot wire gas tungsten arc welding arrangement having a gas tungsten arc torch that produces a welding arc and a filler metal that passes through a delivery guide to the area of the welding arc, the improvement comprising:
an induction coil that is located in close proximity to the welding arc, surrounds the filler metal, and induces a current in the filler metal, producing heat in the filler metal.
